(19) United States
(12) Patent Application Publication
(10) Pub. No.: US 2024/0402304 A1
(43) Pub. Date: Dec. 5, 2024

(54) LIDAR ASSEMBLY WITH STACKED BEAM-STEERING DEVICE

(71) Applicant: Continental Autonomous Mobility US, LLC, Auburn Hills, MI (US)

(72) Inventors: Elliot John Smith, Ventura, CA (US); Jacob A Bergam, Goleta, CA (US); Heiko Leppin, Hergensweiler (DE)

(73) Assignee: Continental Autonomous Mobility US, LLC, Auburn Hills, MI (US)

(21) Appl. No.: 17/938,090

(22) Filed: Oct. 5, 2022

(51) Int. Cl. G01S 7/481; G01S 7/499; G01S 17/931; G02B 5/30

(52) U.S. Cl. CPC G01S 7/4817; G01S 7/4814; G01S 7/4816; G01S 7/499; G01S 17/931; G02B 5/3016

(57) ABSTRACT

A LiDAR system includes a light detector having a field of view, a beam-steering device, and a light emitter aimed at the beam-steering device. The beam-steering device is aimed to emit light from the light emitter into a field of illumination overlapping the field of view. The beam-steering device includes two beam-steering stages each having a polarization grating. The polarization gratings are designed to diffract light from the light emitter based on the polarization state of the light received by the polarization grating. The beam-steering device includes a switchable polarization selector designed to change the polarization state of the light to move the field of illumination relative to the field of view.

### BACKGROUND

A solid-state LiDAR system includes a photodetector, or an array of photodetectors, essentially fixed in place relative to a carrier, e.g., a vehicle. Light is emitted into the field of view of the photodetector and the photodetector detects light that is reflected by an object in the field of view. For example, a Flash LiDAR system emits pulses of light, e.g., laser light, into essentially the entire field of view of the photodetector(s). The time of flight of the reflected photon detected by the photodetector is used to determine the distance of the object that reflected the light. As an example, the solid-state LiDAR system may be mounted on a vehicle to detect objects in the environment surrounding the vehicle and to detect distances of those objects for environmental mapping. The detection of reflected light is used to generate a 3D environmental map of the surrounding environment. The output of the solid-state LiDAR system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

### BRIEF DESCRIPTION OF THE DRAWINGS

FIG. 1 is a perspective view of a vehicle including a LiDAR assembly.

FIG. 2 is a perspective view of the LiDAR assembly.

FIG. 3 is a schematic side view of the LiDAR assembly.

FIG. 4 is a example progression of movement of a field of illumination of the LiDAR assembly moving to discrete positions relative to a field of view of the LiDAR assembly.

FIG. 5A is a schematic view of the discrete positions shown in FIG. 4.

FIG. 5B is a schematic view of another example of discrete positions in which the field of illumination is moved.

FIG. 5C is a schematic view of another example of discrete positions in which the field of illumination is moved.

FIG. 6 is a timing diagram of the movement of the field of illumination shown in FIG. 4 and activation of a light emitter of the LiDAR assembly.

FIG. 7 is a schematic view of a beam-steering device of the LiDAR assembly.

FIG. 8 is an example light-emission system of the LiDAR assembly.

FIG. 9 is another example light-emission system of the LiDAR assembly.

FIG. 10 is another example light-emission system of the LiDAR assembly.

FIG. 11 is a block diagram of components of the LiDAR assembly.

FIG. 12 is a flow chart of an example method of the LiDAR assembly.

### DETAILED DESCRIPTION

With reference to the figures wherein like numerals identify like elements, a LiDAR system 10 includes a light detector 12 having a field of view FOV, a beam-steering device 14, and a light emitter 16 aimed at the beam-steering device 14. The beam-steering device 14 is aimed to emit light from the light emitter 16 into a field of illumination FOI overlapping the field of view FOV. The beam-steering device 14 includes two beam-steering stages 18 each having a polarization grating 20. The polarization gratings 20 are designed to diffract light from the light emitter 16 based on the polarization state of the light received by the polarization grating 20. The beam-steering device 14 includes a switchable polarization selector 36 designed to change the polarization state of the light to move the field of illumination relative to the field of view FOV.

The beam-steering device 14 emits light from the light emitter 16 into the field of illumination FOI that overlaps the field of view FOV of the light detector 12. The beam-steering device 14 moves the field of illumination FOI relative to the field of view FOV. Specifically, the switchable polarization selector 36 changes the polarization state of the light therethrough. The polarization gratings 20 diffract the light differently based on the polarization state of light therethrough. Each switchable polarization selector 36 may operate may alternately emit light having at least two polarization states. Light of each polarization state is diffracted differently by the respective polarization grating 20. The different diffraction of light through the polarization grating 20 steers the light output from the polarization grating 20 at different angles. Accordingly, the switchable polarization selectors 36 may be operated in conjunction to emit different combinations of polarization states to steer the light emitted from the beam-steering device 14 at various angles. This allows a field of illumination FOI smaller than the field of view FOV of the light detector 12 to be moved relative to the field of view FOV to cover the entire FOV in various positions. This reduces the energy required to operate the light emitter 16.

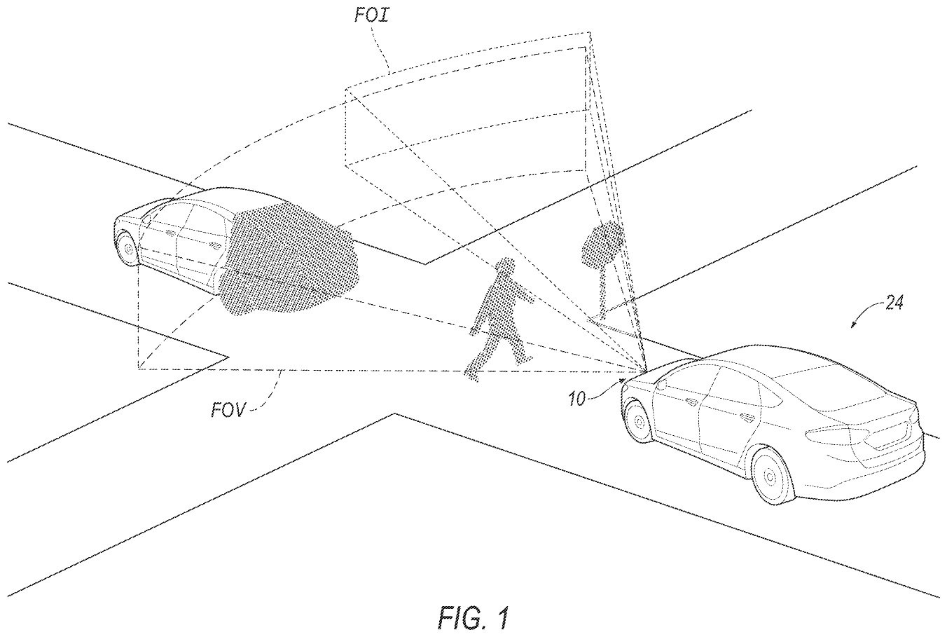

The LiDAR system 10 is shown in FIG. 1 as being mounted on a vehicle 24. The beam-steering device 14 moves the field of illumination FOI relative to the field of view FOV external to the vehicle 24 to illuminate the field of view FOV for use as described further below. Specifically, the LiDAR system 10 is operated to detect objects in the environment surrounding the vehicle 24 and to detect distance, i.e., range, of those objects for environmental mapping. The output of the LiDAR system 10 may be used, for example, to autonomously or semi-autonomously control operation of the vehicle 24, e.g., propulsion, braking, steering, etc. Specifically, the LiDAR system 10 may be a component of or in communication with an advanced driver-assistance system (ADAS) of the vehicle 24. The LiDAR system 10 may be mounted on the vehicle 24 in any suitable position and aimed in any suitable direction. As one example, the LiDAR system 10 is shown on the front of the vehicle 24 and directed forward. The vehicle 24 may have more than one LiDAR system 10 and/or the vehicle 24 may include other object detection systems, including other LiDAR systems. The vehicle 24 shown in the figures is a passenger automobile. As other examples, the vehicle 24 may be of any suitable manned or un-manned type including a plane, satellite, drone, watercraft, etc.

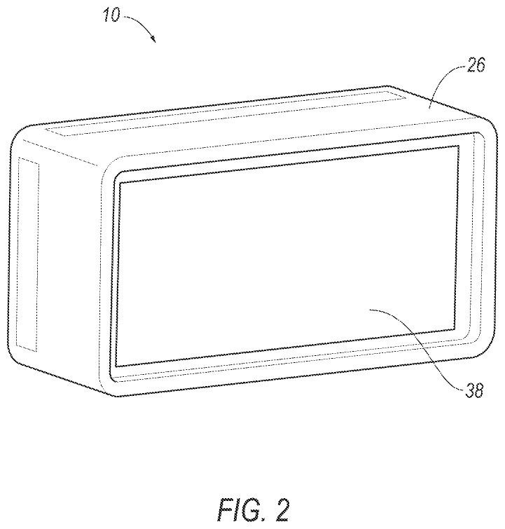

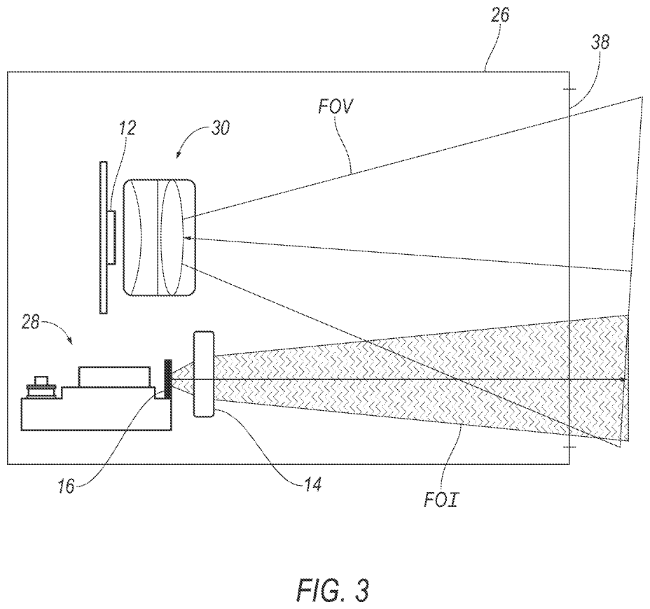

The LiDAR system 10 may be a solid-state LiDAR. In such an example, the LiDAR system 10 is stationary relative to the vehicle 24 or does not experience friction loss from movement (e.g., movement of MEMS is an example of solid-state LiDAR as described below) in contrast to a mechanical LiDAR (e.g., a rotating LiDAR that rotates 360 degrees; LiDAR that includes movement such as translation of a large lens, large mirror, piece of electronics; etc.). The solid-state LiDAR system 10, for example, may include a casing 26 (FIGS. 2-3) that is fixed relative to the vehicle 24, i.e., does not move relative to the component of the vehicle 24 to which the casing 26 is attached, and components of the LiDAR system 10 are supported in the casing 26. As a solid-state LiDAR, the LiDAR system 10 may be a flash LiDAR system. As a flash LiDAR system, the LiDAR system 10 emits pulses, i.e., flashes, of light into the field of illumination FOI. More specifically, the LiDAR system 10 may be a 3D flash LiDAR system that generates a 3D environmental map of the surrounding environment. In a flash LiDAR system, the FOI illuminates an FOV of the light detector 12, e.g., a 2D array of photodetectors. Another example of solid-state LiDAR includes an optical-phase array (OPA). Another example of solid-state LiDAR is a micro-electro-mechanical system (MEMS) scanning LiDAR, which may also be referred to as a quasi-solid-state LiDAR.

With reference to FIG. 1, the LiDAR system 10 emits light and detects the emitted light that is reflected by an object, e.g., pedestrians, street signs, vehicles 24, etc. Specifically, the LiDAR system 10 includes a light-emission system 28, a light-receiving system 30, and a controller 22. The controller 22 controls the light-emission system 28 and the light-receiving system 30.

With reference to FIG. 3, the light-emission system 28 may include one or more light emitter 16 and one or more beam-steering devices 14. The light emitter 16 is aimed at the beam-steering device 14. Specifically, light emitted from the light emitter 16 is received by the beam-steering device 14 and the beam-steering device 14 emits the light through a window 38 to an exterior of the LiDAR system 10.

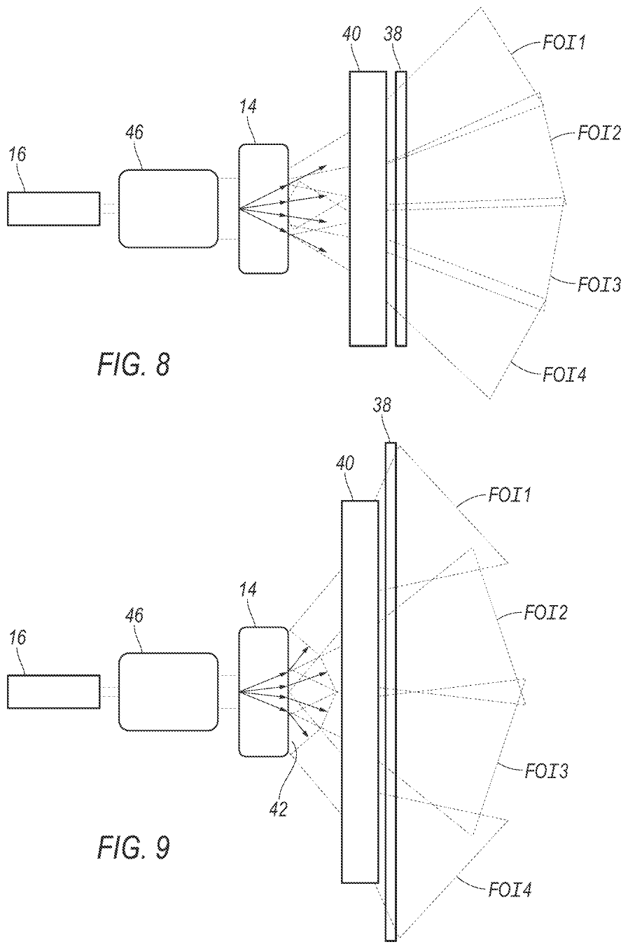

The light-emission system 28 may include optical components. Light from the light emitter 16 may pass through intermediate components, e.g., optical components, from the light emitter 16 to the beam-steering device 14. The optical components may include an optical element, reflectors/deflectors, diffusers, a collimating lens, transmission optics, a lens package, lens crystal, pump delivery optics, etc. The optical components direct the light, e.g., in the casing 26 from the light emitter 16 to the window 38, and shapes the light, etc. With reference to the examples shown in the figures, the optical components may include a beam expander 46 (FIGS. 8-10), a diffuser, a prism, and/or a lens. For example, the beam expander 46 may be between the light emitter 16 and the beam-steering device 14. The prism and/or lens may be between the beam-steering device 14 and the window 38. The diffuser may be, for example, between the beam-steering device 14 and the window 38. In such an example, the prism and/or lens may be between the beam-steering device 14 and the diffuser.

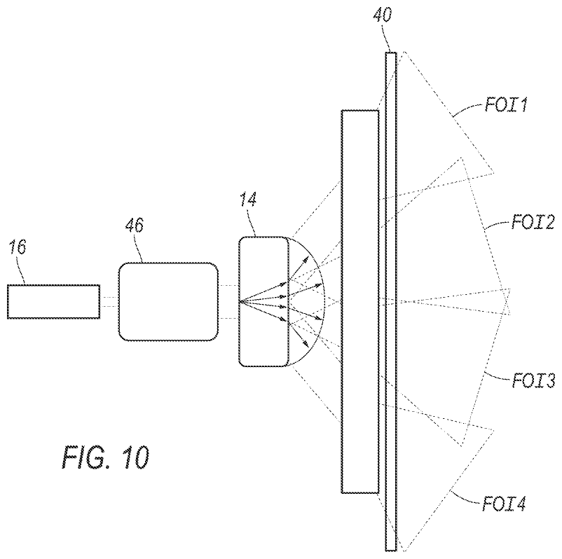

Three examples are shown in FIGS. 8-10. Each of FIGS. 8-10 show four example fields of illumination FOI that are alternatively emitted from the light-emission system 28 (all four example fields of illumination FOI are shown simultaneously in the figures but are emitted alternatively during operation of the light-emission system 28). In FIG. 8, the light-emission system 28 includes a diffuser 40 between the beam-steering device 14 and the window 38 to diffuse light emitted from the beam-steering device 14. In FIG. 9, the light-emission system 28 includes a diffuser 40 and a prism 42 between the beam-steering device 14 and the diffuser 40. The prism 42 directs the light from the beam-steering device 14 to the diffuser 40 and the diffuser 40 diffuses the light into the field of illumination FOI. In FIG. 10, the light-emission system 28 includes a diffuser 40 and a lens 44 between the beam-steering device 14 and the diffuser 40. The lens 44 directs light from the beam-steering device 14 to the diffuser 40 and the diffuser 40 diffuses the light into the field of illumination FOI.

The light emitter 16 emits light through the window 38 to a field of illumination FOI exterior to the LiDAR system 10 for illuminating objects in the field of illumination FOI for detection. The optical components of the light-emission system 28 may shape, focus, and/or direct the light from the light emitter 16 and/or the beam-steering device 14 through the window to a field of illumination FOI. The light emitter 16 in the example shown in the figures illuminates a field of illumination FOI with a flash of light. In the example shown in the figures, the field of illumination FOI is smaller than the field of view FOV of the light detector 12. The controller 22 is in communication with the light emitter 16 for controlling the emission of light from the light emitter 16 including the timing of light emission. The controller 22 also controls the beam-steering device 14, as described further below, to aim the light exterior to the LiDAR system 10.

The light emitter 16 may be configured to emit shots, i.e., pulses, of light into the field of illumination FOI for detection by a light-receiving system 30 when the light is reflected by an object in the field of view FOV to return photons to the light-receiving system 30. The light-receiving system 30 has a field of view FOV that overlaps the field of illumination FOI and receives light reflected by surfaces of objects, buildings, road, etc., in the FOV. The light emitter 16 may be in electrical communication with the controller 22, e.g., to provide the shots in response to commands from the controller 22.

The light emitter 16 emits light into the field of illumination FOI for detection by the light-receiving system 30 when the light is reflected by an object in the field of view FOV FOV. The light emitter 16 may be, for example, a laser. The light emitter 16 may be, for example, a semiconductor light emitter, e.g., laser diodes. In one example, the light emitter 16 may be a diode-pumped solid-state laser (DPSSL). In another example, the light emitter 16 is a vertical-cavity surface-emitting laser (VCSEL). As another example, the light emitter 16 may be an edge emitting laser diode. The light emitter 16 may be designed to emit a pulsed flash of light, e.g., a pulsed laser light. Specifically, the light emitter 16, e.g., the DPSSL or VCSEL or edge emitter, is designed to emit a pulsed laser light or train of laser light pulses. The light emitted by the light emitter 16 may be, for example, infrared light. Alternatively, the light emitted by the light emitter 16 may be of any suitable wavelength. The LiDAR system 10 may include any suitable number of light emitters 16, i.e., one or more in the casing 26. In examples that include more than one light emitter 16, the light emitters 16 may be identical or different.

The light emitter 16 has a field of illumination FOI that overlaps the field of view FOV of the light-receiving system 30 and the light-receiving system 30 receives light reflected by objects in the field of view FOV. As described further below, the beam-steering device 14 moves the field of illumination FOI of the light emitter 16 relative to the field of view FOV of the light detector 12 to scan the field of view FOV and direct light from sections of the field of view FOV to the light detector 12. The light-receiving system 30 includes the light detector 12 and may include receiving optics (shown schematically in FIG. 3), which may be or include the optical components described above. The receiving optics may be of any suitable type and size. As set forth above, the light-receiving system 30 includes the light detector 12 including the array of photodetectors, i.e., a photodetector array. The light detector 12 includes a chip and the array of photodetectors is on the chip. The chip may be silicon (Si), indium gallium arsenide (InGaAs), germanium (Ge), etc., as is known. The chip and the photodetectors are shown schematically. The array of photodetectors is 2-dimensional. Specifically, the array of photodetectors includes a plurality of photodetectors arranged in columns and rows.

Each photodetector of the light detector 12 is light sensitive. Specifically, each photodetector detects photons by photo-excitation of electric carriers. An output signal from the photodetector indicates detection of light and may be proportional to the amount of detected light. The output signals of each photodetector are collected to generate a scene detected by the photodetector. The photodetectors may be of any suitable type, e.g., photodiodes (i.e., a semiconductor device having a p-n junction or a p-i-n junction) including avalanche photodiodes (which may be operated linearly or as a single-photon avalanche diode (SPAD)), metal-semiconductor-metal photodetectors, phototransistors, photoconductive detectors, phototubes, photomultipliers, etc. As an example, the photodetectors may each be a silicon photomultiplier (SiPM). As another example, the photodetectors may each be or include a PIN diode. The photodetectors may be sensitive to light in any suitable wavelength. For example, the photodetectors may be sensitive to visible light, infrared light, and/or any other suitable wavelength.

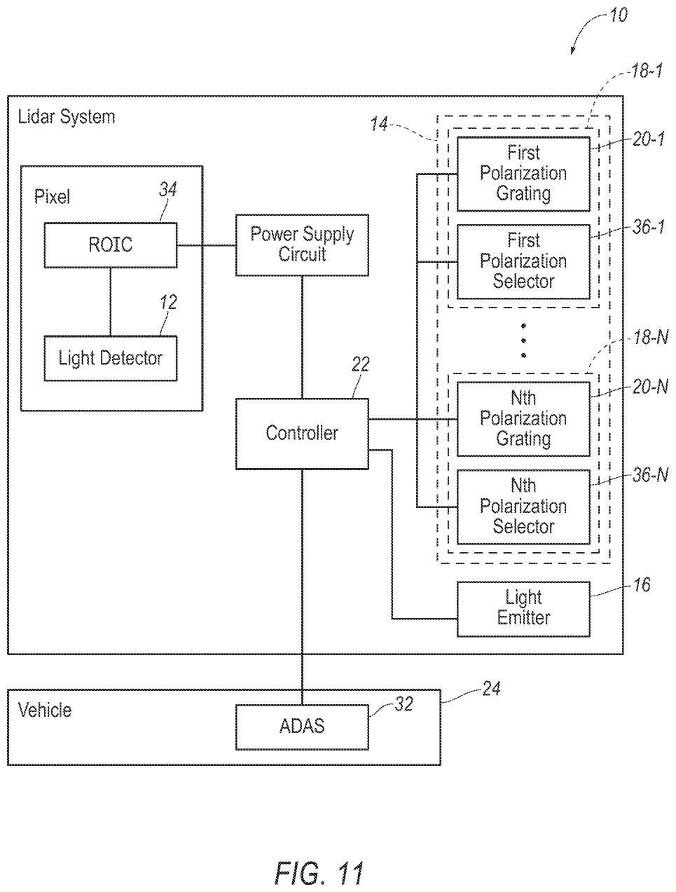

With reference to FIG. 11, each photodetector may be a component of a pixel. The LiDAR system 10 includes multiple pixels, and each pixel can include one or more photodetectors each configured to detect incident light. For example, a pixel can output a count of incident photons, a time between incident photons, a time of incident photons (e.g., relative to an illumination output time), or other relevant data, and the system can transform these data into distances from the LiDAR system 10 to external surfaces in the fields of view FOV of these pixels. By merging these distances with the position of pixels at which these data originated and relative positions of these pixels at a time that these data were collected, the LiDAR system 10 (or other device accessing these data) can reconstruct a three-dimensional (virtual or mathematical) model of a space occupied by the LiDAR system 10, such as in the form of 3D image represented by a rectangular matrix of range values, wherein each range value in the matrix corresponds to a polar coordinate in 3D space. The pixel functions to output a single signal or stream of signals corresponding to a count of photons incident on the pixel within one or more sampling periods. Each sampling period may be picoseconds, nanoseconds, microseconds, or milliseconds in duration. The pixel can output a count of incident photons, a time between incident photons, a time of incident photons (e.g., relative to an illumination output time), or other relevant data, and the LiDAR system 10 can transform these data into distances from the system to external surfaces in the fields of view of these pixels. By merging these distances with the position of pixels at which these data originated and relative positions of these pixels at a time that these data were collected, the controller 22 (or other device accessing these data) can reconstruct a three-dimensional 3D (virtual or mathematical) model of a space within field of view FOV, such as in the form of 3D image represented by a rectangular matrix of range values, wherein each range value in the matrix corresponds to a polar coordinate in 3D space. The pixels may be arranged as an array, e.g., a 2-dimensional (2D) or a 1-dimensional (1D) arrangement of components. A 2D array of pixels includes a plurality of pixels arranged in columns and rows. Each pixel may include a power-supply circuit or may share one or more power-supply circuits of the LiDAR system 10. Each pixel may include a read-out integrated circuit (ROIC) or multiple pixels may share a ROIC 34.

The light-receiving system 30 includes the ROIC 34 for converting an electrical signal received from photodetectors of the array of photodetectors to digital signals. The ROIC 34 may include electrical components which can convert electrical voltage to digital data. The ROIC 34 may be connected to the controller 22, which receives the data from the ROIC 34 and may generate 3D environmental map based on the data received from the ROIC 34.

The light-receiving system 30 may include passive electrical components such as capacitors, resistors, etc. The light-receiving system 30 and the light-emission system 28 may be optically separated from one another by an optical barrier. An optical barrier may be formed of plastic, glass, and/or any other suitable material that blocks passage of light. In other words, an optical barrier prevents detection of light emitted from the light-emission system 28, thus limiting the light received by the light-receiving system 30 to light received from the field of view FOV of the LiDAR system 10.

Data output from the ROIC 34 may be stored in a memory chip for processing by the controller 22. The memory chip may be a DRAM (Dynamic Random Access Memory), an SRAM (Static Random Access Memory), and/or a MRAM (Magneto-resistive Random Access Memory) may be electrically connected to the ROIC 34. In one example, an light-receiving system 30 may include the memory chip electrically connected to the ROIC 34. Additionally or alternatively, the memory chip can be a separate chip.

With reference to FIGS. 2-3, the LiDAR system 10 may be a unit. Specifically, the casing 26 supports the light-emission system 28 and the light-receiving system 30. The casing 26 may enclose the light-emission system 28 and the light-receiving system 30. The casing 26 may include mechanical attachment features to attach the casing 26 to the vehicle 24 and electronic connections to connect to and communicate with electronic system of the vehicle 24, e.g., components of the ADAS. The casing 26, for example, may be plastic or metal and may protect the other components of the LiDAR system 10 from moisture, environmental precipitation, dust, etc. In the alternative to the LiDAR system 10 being a unit, components of the LiDAR system 10, e.g., the light-emission system 28 and the light-receiving system 30, may be separated and disposed at different locations of the vehicle 24.

The window 38 extends through the casing 26 and may include a lens or other optical device at the casing 26. The window 38 may include one or more segments. In the example shown in the figures, the LiDAR system 10 includes one segment through which light from the light emitter 16 is emitted and light returned from the field of illumination FOI to the light sensor is transmitted through the one segment of the LiDAR system 10. As another example, the window 38 may include one segment for the light emitter 16 and one segment for the light detector 12. In examples in which the window 38 includes more than one segment, the segments may be separated by portions of the casing 26, e.g., plastic, metal, etc.

The window 38 allows light to pass through, e.g., light generated by the light-emission system 28 exits the LiDAR system 10 and/or light from environment enters the LiDAR system 10. The window 38 protects an interior of the LiDAR system 10 from environmental conditions such as dust, dirt, water, etc. The window 38 is a transparent or semi-transparent material, e.g., glass, plastic, with respect to the wavelength of the emitted light. The window 38 may be opaque at other wavelengths, which may assist in the overall reduction of ambient light, e.g., may include a bandpass filter. The window 38 may extend from the casing 26 and/or may be attached to the casing 26.

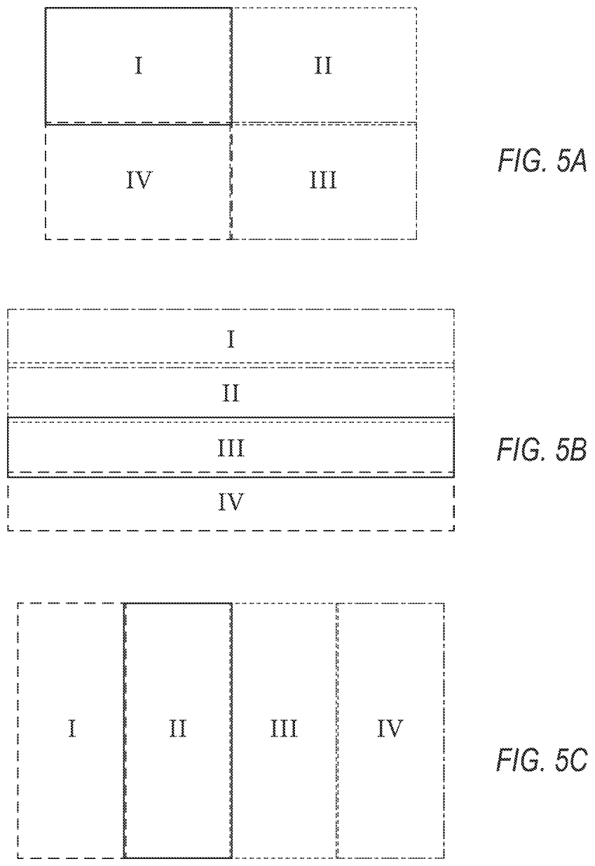

The beam-steering device 14 directs and/or diffuses the light from the light emitter 16 into the field of view FOV. Specifically, the aim of the beam-steering device 14 may be controlled to, at least in part, shape the light from the light emitter 16 into a field of illumination FOI that is smaller than the field of view FOV of the light detector 12 and overlaps the field of view FOV of the light detector 12. Specifically, the beam-steering device 14 is designed to aim light from the light emitter 16 into the field of illumination, which is positioned to be detected by the light detector 12. The field of illumination may be elongated horizontally across the field of view FOV (FIG. 5B), elongated vertically across the field of view FOV (FIG. 5C), or may overlap any portion of the field of view FOV, e.g., quadrants (FIG. 5A).

As set forth above, the field of illumination FOI is smaller than the field of view FOV and the beam-steering device 14 aims the field of illumination FOI into the field of view FOV of the light detector 12 such that the field of illumination FOI is positioned to be detected by the light detector 12, i.e., to detect light that is reflected by an object in the field of view FOV. The beam-steering device 14 is designed to move the field of illumination FOI vertically and/or horizontally to discrete positions and light is emitted at each discrete position. The discrete positions are “discrete” in that the positions are individually distinct from each other. The discrete positions may overlap adjacent discrete positions. The discrete positions may be stopped positions or may be temporal, i.e., positions at different times. Said differently, as one example, the beam-steering device 14 may stop the scan of the field of illumination at each discrete vertical position and light is emitted at each discrete vertical position. As another example, the beam-steering device 14 may continuously scan (i.e., without stopping) the field of illumination FOI and each discrete position is a different position of the scan at different times. The beam-steering device 14 scans through a sequence of the discrete positions. For example, the position sequence may be a sequence of stopped positions or a sequence of times during a continuous scan, as described above. Each discrete position in the sequence may be adjacent or overlapping the previous discrete position and the following discrete position in the sequence. The light emitter 16 emits a flash of light, or flashes of light, at each discrete position. The discrete positions, in combination, cover the entire field of view FOV so that the scenes detected by the light detector 12 at each discrete position can be combined into a frame including light detected in the entire field of view FOV. Horizontal and vertical are used herein relative to gravity.

The beam-steering device 14 is aimed at the field of view FOV. The beam-steering device 14 is designed to adjust the aim of the beam-steering device 14 to move the field of illumination relative to the light detector 12. For example, when the beam-steering device 14 is aimed in the first discrete position, the FOI is aimed at a first segment of the field of view FOV detectable by a first segment of the array of photodetectors. In other words, if light is reflected by an object in the FOI at the first discrete position, the reflected light is detected by the first segment of the array of photodetectors. Likewise, when the beam-steering device 14 is aimed at the second discrete position, the FOI is aimed at a second segment of the field of view FOV detectable by a second segment of the array of photodetectors. Each photodetector of the array of photodetectors is illuminated at least once in the combination of all discrete positions of the FOI. The scan of discrete positions has a range. The range may be +/−40 degrees about a vertical axis and +/−40 degrees about a horizontal axis.

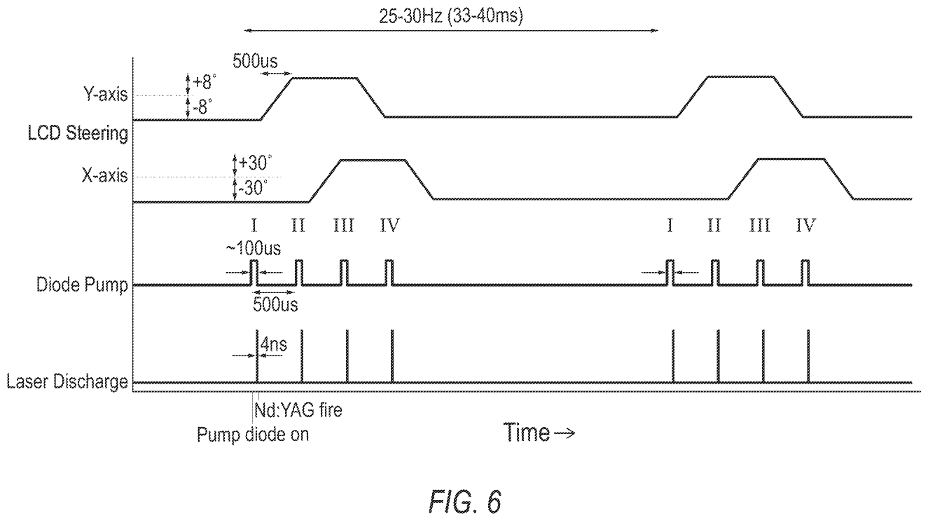

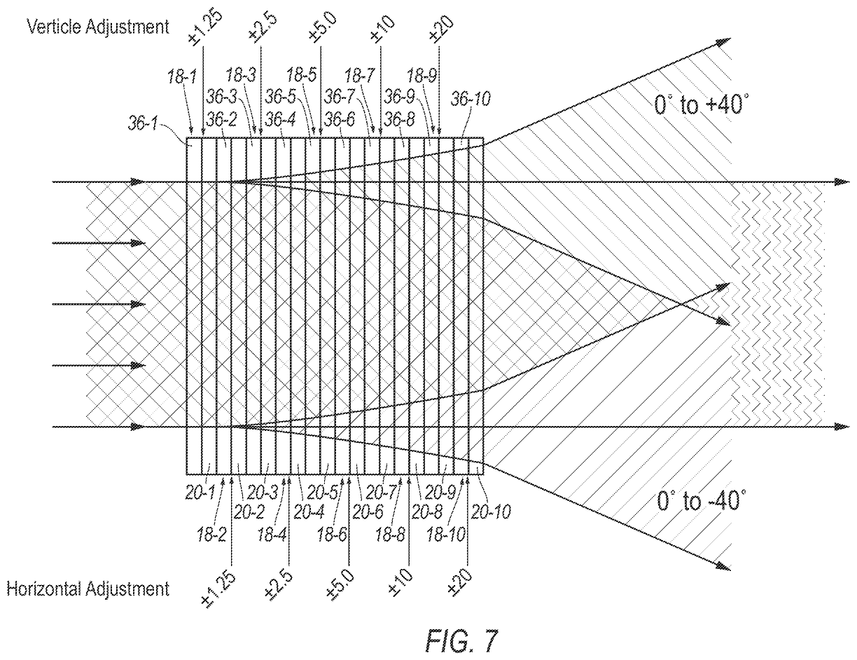

As set forth above, the beam-steering device 14 includes a plurality of beam-steering stages 18, e.g., the first beam-steering stage 18-1, the second beam-steering stage 18-2, a third beam-steering stage 18-3, etc. The bream-steering stages 18 may be stacked on each other, as shown in FIG. 7. The example shown in FIG. 7 includes ten beam-steering stages 18. The example shown in FIG. 11 includes N number of beam-steering stages 18 to identify that the beam-steering device 14 may have any suitable number of beam-steering stages 18. The beam-steering stages 18 are adjustable relative to each other to adjust the field of illumination FOI relative to the field of view FOV, as described above. For example, in the example shown in FIG. 7, five of the ten beam-steering stages 18 adjust azimuth and five of the ten beam-steering stages adjust elevation. The beam-steering stages 18 that adjust azimuth adjust the aim on the x-axis on FIG. 6 and the beam-steering stages 18 that adjust elevation adjust the aim on the y-axis on FIG. 6. In other examples, each of the beam-steering stages 18 may adjust the aim on the x-axis, e.g., FIG. 5B. In other examples, each of the beam-steering stages 18 may adjust the aim on the y-axis, e.g., FIG. 5C. The steering may be non-mechanical, and more specifically, electrically controlled. Specifically, the beam-steering stages 18 include one or more stacked liquid crystal layers (e.g., liquid crystal layers of switchable wave plates, switchable polarization gratings, etc.), as described further below. Examples of the beam-steering device 14 include, for example, those disclosed in U.S. Pat. No. 8,982,313 to Escuti et al., which is incorporated herein by reference.

With reference to FIG. 7, as discussed in greater detail below, non-mechanical beam steering devices of the example embodiments include two or more beam-steering stages 18, each having at least one polarization grating 20 and at least one switchable polarization selector 36. In some examples, each beam-steering stage 18b provides three possible steering directions, such that each beam-steering stage 18b can both add and subtract from the steered angles. Such a ternary design enables a wider range of angles to be steered by the same number of elements.

The polarization grating 20 is designed to diffract light from the light emitter 16 based on the polarization state of the light received by the polarization grating 20. In other words, light having different polarization states are diffracted differently by the polarization grating 20. In each beam-steering stage 18, the switchable polarization selector 36 is designed to change the polarization state of the light and the adjustment of the polarization state of the light changes the diffraction by the polarization grating 20, which changes the aim of the light exiting the polarization grating 20. The beam-steering stages 18b are controlled in combination to steer the light emitted from the beam-steering device 14, i.e., to move the field of illumination relative to the field of view FOV.

The switchable polarization selector 36 includes a switchable liquid crystal layer operable to be switched between a first state that does not substantially affect the polarization of light traveling therethrough and a second state that alters the polarization of the light traveling therethrough. As one example, the switchable polarization selector 36 may be a liquid crystal waveplate (including a liquid crystal layer) that switches the handedness of the incident light (i.e. right circularly polarized to left circularly polarized or left circularly polarized to right circularly polarized, but under external applied voltage the liquid crystal waveplate allows the incoming light to pass through without changing its polarization state. As set forth above, the polarization grating 20 diffracts light differently based on the polarization state of the light, e.g., whether the light is right circularly polarized or left circularly polarized.

In some examples, the polarization gratings 20 are active. Specifically, the polarization gratings 20 each include a switchable liquid crystal layer that diffracts incident light based on applied voltage to the polarization grating 20. The polarization gratings 20 may diffract incident light into one of the three diffracted orders (0th and ±1st) based on the input polarization and the applied voltage. For example, when no voltage is applied to the polarization grating 20, depending on the handedness of the circular polarization, the polarization grating 20 diffracts the incident light into one of the #1st orders (+θ or −θ) and flips (i.e., reverses) its handedness. When a voltage is applied, the grating profile is effectively erased and the incident light passes through the polarization grating 20 preserving its polarization state (m=0) without diffraction. In examples in which the polarization gratings 20 are active, the controller 22 selectively applies voltage to the switchable liquid crystal layer of the switchable polarization selector 36 to steer the field of illumination FOI relative to the field of view FOV of the light detector 12.

In some examples, the polarization gratings 20 are passive. Specifically, each polarization grating 20 has a constant diffraction based on the polarization state of incident light. In other words, the polarization grating 20 diffracts light differently based on the polarization state of the light, but the polarization grating 20 is not switchable. In other words, the passive polarization grating 20 is not activated by applied voltage to change between different diffracted orders. In contrast, the passive polarization grating 20 is fixed to diffract light at one diffractive order. In such an example, each beam-steering stage 18b includes at least one switchable polarization selector and at least one passive polarization gratings 20. The controller 22 selectively applies voltage to the switchable liquid crystal layer of the switchable polarization selector 36 to steer the field of illumination FOI relative to the field of view FOV of the light detector 12.

Non-mechanical beam steering devices described herein are based on the polarization sensitive properties of the polarization gratings 20 described herein. In particular, polarization gratings 20 according to embodiments of the disclosure are capable of diffracting incident light into one of the three diffracted orders (0th and ±1st), based on the input polarization and the applied voltage. The polarization gratings 20 can provide very high diffraction efficiency (for example, up to about 100%) for various diffraction angles. Also, the thickness of the polarization gratings 20 is independent of the aperture size, allowing for relatively wide angle steering with large aperture. Moreover, since the polarization gratings 20 are relatively thin diffractive elements, beam steering devices according to some embodiments of the present disclosure may be relatively compact and/or light weight. Particular embodiments of the present disclosure provide a three-stage beam steerer including multiple stacked beam steering stages that provides several dozen discrete steering angles with high throughput (for example, about 80% to about 95%) within a wide field-of-regard (FOR) of up to about 90°. This ternary design uses minimum steering stages for the same steering angles and the number of steering angles is increased exponentially as increasing the number of stages.

Liquid crystal layers (e.g., those of switchable wave plates, switchable polarization gratings, etc.) have liquid crystals that can have a nematic phase, a chiral nematic phase, a smectie phase, a ferroelectric phase, and/or another phase. In addition, a number of photopolymerizable polymers may be used as alignment layers to create the polarization gratings 20 described herein. In addition to being photopolymerizable, these materials may be inert with respect to the liquid crystals, should provide stable alignment over a range of operating temperatures of the LC device (e.g., from about −50° C. to about 100° C.), and should be compatible with manufacturing methods described herein. Some examples of photopolymerizable polymers include polyimides (e.g., AL 1254 commercially available from JSR Micro, Inc (Sunnyvale, Calif.)), Nissan RN-1199 available from Brewer Science, Inc. (Rolla, Mo.), and cinnamates (e.g., polyvinyl 4-methoxy-cinnamate as described by M. Schadt et al., in “Surface-Induced Parallel Alignment of Liquid Crystals by Lincarly Polymerized Photopolymers,” Jpn. J. Appl. Phys., Vol. 31 (1992), pp. 2155-2164). Another example of a photopolymerizable polymer is Staralign™, commercially available from Vantico Inc. (Los Angeles, Calif.). Further examples include chalcone-epoxy materials, such as those disclosed by Dong Hoon Choi and co-workers in “Photo-alignment of Low-molecular Mass Nematic Liquid Crystals on Photochemically Bifunctional Chalcone-epoxy Film by Irradiation of a Linearly Polarized UV,” Bull. Korean Chem. Soc., Vol. 23, No. 4 587 (2002), and coumarin side chain polyimides, such as those disclosed by M. Ree and co-workers in “Alignment behavior of liquid-crystals on thin films of photosensitive polymers—Effects of photoreactive group and UV-exposure,” Synth. Met., Vol. 117 (1-3), pp. 273-5 (2001) (with these materials, the LC aligns nearly perpendicularly to the direction of polarization). Additional examples of methods of liquid crystal alignment are also discussed in and U.S. Pat. No. 7,196,758 to Crawford et al. Furthermore, some structures described herein may involve precise fabrication through a balance of spin-coating processes and liquid crystal materials. Additional structures and/or methods for use with some embodiments of the present disclosure are discussed in PCT Publication Nos. WO 2006/092758, WO 2008/130559, WO 2008/130561, and WO 2008/130555 to Escuti, et al., as well as pending PCT Application No. PCT/US2008/011611 to Escuti, et al.

“Polymerizable liquid crystals” as used herein refer to relatively low-molecular weight liquid crystal materials that can be polymerized. In contrast, “non-reactive liquid crystals” may refer to relatively low-molecular weight liquid crystal materials that may not be polymerized. Also, as used herein, “zero-order” light propagates in a direction substantially parallel to that of the incident light, i.e., at a substantially similar angle of incidence, and may be referred to herein as “on-axis” light. For example, in several of the embodiments described in detail below, the incident light is normal to the first polarization grating 20; thus, “zero-order” or “on-axis” light would also propagate substantially normal to the first polarization grating 20 in these embodiments. In contrast, “non-zero-order light”, such as “first-order” light, propagates in directions that are not parallel to the incident light, and is referred to herein as “off-axis” light.

With reference to FIG. 11, the controller 22 is in electronic communication with the light emitter 16 and the light detector 12 (e.g., with the ROIC 34 and power-supply circuit) to transmit commands and to receive data. The controller 22 may be in electronic communication with the vehicle 24 (e.g., with the ADAS) to receive data and transmit commands. The controller 22 may be configured to execute operations disclosed herein, including in method 1200.

The controller 22 may be a microprocessor-based controller 22 or field programmable gate array (FPGA), or a combination of both, implemented via circuits, chips, and/or other electronic components. In other words, the controller 22 is a physical, i.e., structural, component of the system. The controller 22 includes the processor, memory, etc. The memory of the controller 22 may store instructions executable by the processor, i.e., processor-executable instructions, and/or may store data. The controller 22 may be in communication with a communication network of the vehicle 24 to send and/or receive instructions from the vehicle 24, e.g., components of the ADAS. The instructions stored on the memory of the controller 22 include instructions to perform the method 1200 in the Figures. Use herein (including with reference to the method 1200 in the Figures) of “based on,” “in response to,” and “upon determining,” indicates a causal relationship, not merely a temporal relationship. The controller 22 includes a processor and a memory. The memory includes one or more forms of controller-readable media, and stores instructions executable by the controller 22 for performing various operations, including as disclosed herein. Additionally or alternatively, the controller 22 may include a dedicated electronic circuit including an ASIC (Application Specific Integrated Circuit) that is manufactured for a particular operation, e.g., calculating a histogram of data received from the LiDAR system 10 and/or generating a 3D environmental map for a Field of View (FOV) of the vehicle 24. In another example, the controller 22 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller 22 may be a set of controllers communicating with one another via the communication network of the vehicle 24, e.g., a controller 22 in the LiDAR system 10 and a second controller 22 in another location in the vehicle 24.

The controller 22 may control operations of the vehicle 24 and/or may provide data for control of vehicle operation in an autonomous, a semi autonomous mode, or a non autonomous (or manual) mode. For purposes of this disclosure, an autonomous mode is defined as one in which each of vehicle propulsion, braking, and steering are controlled by, for example, the controller 22; in a semi autonomous mode the controller 22, as an example, controls one or two of vehicle propulsion, braking, and steering; in a non autonomous mode a human operator controls each of vehicle propulsion, braking, and steering. The controller 22 may include programming to operate one or more of vehicle brakes, propulsion (e.g., control of acceleration in the vehicle 24 by controlling one or more of an internal combustion engine, electric motor, hybrid engine, etc.), steering, climate control, interior and/or exterior lights, etc., as well as to determine whether and when the controller 22, as opposed to a human operator, is to control such operations. Additionally, the controller 22 may be programmed to determine whether and when a human operator is to control such operations.

The controller 22 may include or be communicatively coupled to, e.g., via a vehicle 24 communication bus, more than one processor, e.g., controllers or the like included in the vehicle 24 for monitoring and/or controlling various vehicle 24 controllers, e.g., a powertrain controller 22, a brake controller 22, a steering controller 22, etc. The controller 22 is generally arranged for communications on a vehicle 24 communication network that can include a bus in the vehicle 24 such as a controller 22 area network (CAN) or the like, and/or other wired and/or wireless mechanisms.

The controller 22 is programmed to adjust the aim of the beam-steering device 14 to move the field of illumination relative to the field of view FOV and to detect light returned to the LiDAR system 10. Specifically, the controller 22 is programmed to control the beam-steering stages 18 by controlling the switchable polarization selectors 36. As an example, the controller 22 programmed to selectively apply voltage to the switchable liquid crystal layers of the switchable polarization selectors 36. In examples in which the polarization grating 20 is active, the controller 22 also controls the beam-steering stages 18 by controlling the polarization grating 20, e.g., by selectively applying voltage to the switchable liquid crystal layers of the polarization grating 20.

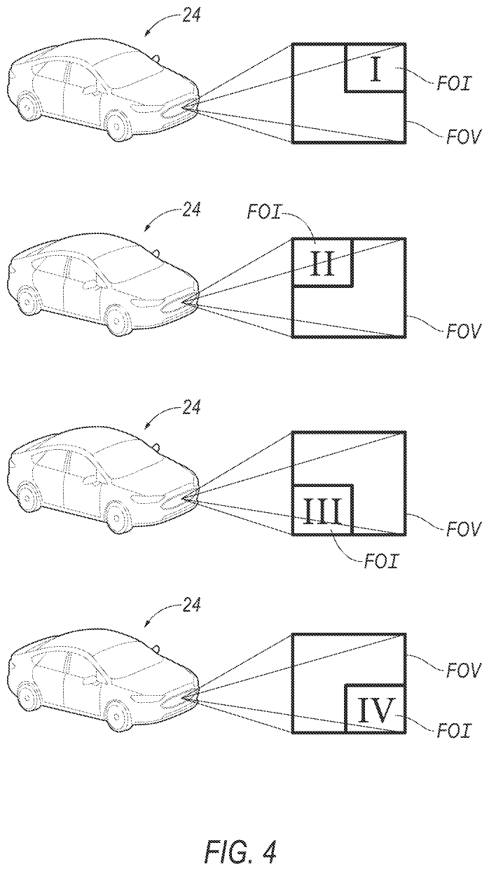

FIG. 6 is an example of operation of the beam-steering device 14 and the light emitter 16. The steering output of the beam-steering device 14 in the example in FIG. 6 is shown in FIGS. 4 and 5A. Specifically, when the beam-steering device 14 is in position I, the light emitter 16 is discharged. The controller 22 then selectively applies voltage to the beam-steering stages 18, as described above, to adjust the aim of the beam-steering device 14 vertically from position I to position II and the light emitter 16 is discharged at position II. The controller 22 then selectively applies voltage to the beam-steering stages 18 to adjust the aim of the beam-steering device 14 vertically from position II to position III and the light emitter 16 is discharged at position III. The controller 22 then selectively applies voltages to the beam-steering stages 18 to adjust the aim of the beam-steering device 14 horizontally from position III to position IV and the light emitter 16 is discharged at position IV. The light detector 12 is activated each time the light emitter 16 is discharged, i.e., at each of positions I, II, III, and IV, to detect light returned to the light detector 12 from the field of view FOV. The scenes detected at positions I, II, III, and IV are combined to generate a scene of the entire field of view FOV. As another example, in FIG. 5B, the controller 22 adjusts each of the beam-steering stages 18 to adjust the field of illumination vertically, e.g., FIG. 5B. As another examples, in FIG. 5C, the controller 22 adjusts each of the beam-steering stages 18 to adjust the field of illumination horizontally, e.g., FIG. 5C.

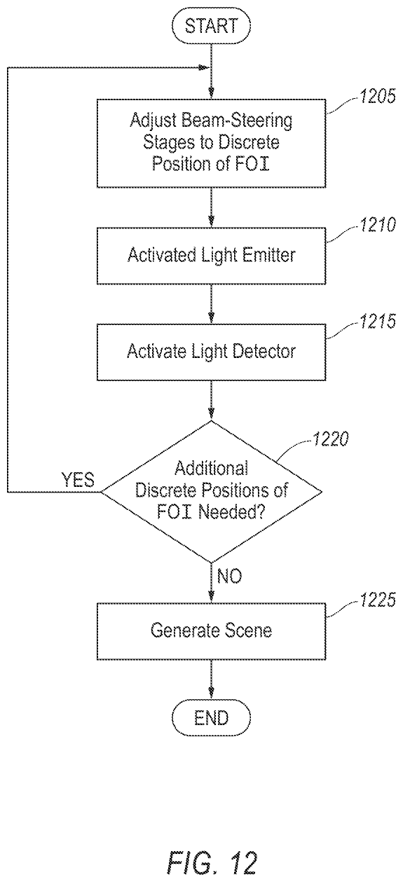

With reference to FIG. 12, the method 1200 for operating the LiDAR system 10 is generally shown. The method 1200 includes adjusting the aim of a beam-steering device 14 relative to a field of view FOV of a light detector 12, with reference to block 1205. This steers the field of illumination FOI to one of the discrete positions, as described above. Specifically, the method includes adjusting at least one of the beam-steering stages 18. As set forth above, adjusting the beam-steering stage 18 may, for example, be accomplished by adjusting at least one of the switchable polarization selectors 36, e.g., a first switchable polarization selector 36-1 of a first beam-steering stage 18-1 of the beam-steering device 14 and/or a second switchable polarization selector 36-1 of a second beam-steering stage 18-2 of the beam-steering device 14.

With continued reference to block 1205, adjusting the beam-steering stages 18 may include selectively applying voltage to the switchable liquid crystal layer of the switchable polarization selector 36 of the beam-steering stage 18, e.g., the switchable liquid crystal layer of the first switchable polarization selector 36-1, the switchable liquid crystal layer of the second switchable polarization selector 36-2, etc.

With continued reference to block 1205, in examples in which the polarization grating 20 of the beam-steering stage 18 is active, in addition to selectively applying voltage to the switchable liquid crystal layer of the switchable polarization selector 36, adjusting the beam-steering stage 18 may include selectively applying voltage to the switchable liquid crystal layer of the polarization grating 20, e.g., the switchable liquid crystal layer of the first polarization grating 20-1, the switchable liquid crystal layer of the second polarization grating 20-2, etc.

With reference to block 1210, the method 1200 includes activating a light emitter 16 aimed at the beam-steering device 14 to emit light into the field of view FOV of the light detector 12. As described above, the light from the light emitter 16 is diffracted by the beam-steering stages 18 to aim the light into the field of view FOV.

With reference to block 1215, the method 1200 includes activating the light detector 12 to detect light returned from the field of view FOV. Specifically, the light detector 12 is operated so that light returned from the field of illumination FOI that illuminates a portion of the field of view FOV is detected by the light detector 12.

With reference to block 1220, the method 1200 includes determining whether additional discrete positions of the field of illumination FOI are needed. As set forth above, in one discrete position, the field of illumination FOI is smaller than the field of view FOV of the light detector 12. Accordingly, only a portion of the scene that could be detected in the field of view FOV is illuminated. In some examples, the scene may be generated in block 1225, as described further below, based on illumination at one discrete position of the field of illumination FOI. In other examples, the method 1200 includes adjusting the aim of the beam-steering device 14 relative to the field of view FOV to various discrete positions and detecting light returned from the field of view FOV with the light detector 12 at each of the discrete positions. Specifically, the field of illumination FOI is moved to a plurality of discrete positions to illuminate more of the field of view FOV, e.g., the entire field of view FOV. For example, the method 1200 may repeat blocks 1205-1215 for each of the four positions I, II, III, IV shown in FIGS. 4, 5A, and 6. In such an example, the method 1200 includes selective application of voltage to the beam-steering stages 18 and activation of the light emitter 16 according to the timing shown in FIG. 6, as an example. As other examples, the method 1200 may repeat blocks 1205-1215 for each of the four positions I, II, III, IV shown in FIGS. 5B and 5C.

With reference to block 1225, when blocks 1205-1215 are completed for each of the discrete positions, the method 1200 includes generating the scene from the field of view based on light detected at each of the discrete positions of the field of illumination FOI, as described above. Specifically, the method 1200 includes generating a scene at each discrete position based on the light detected by the light detector and combining the scenes, e.g., for the entire field of view FOV. The vehicle 24 may then use this combined scene as described above.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A LiDAR system comprising:
a light detector having a field of view;
a beam-steering device; and
a light emitter aimed at the beam-steering device;
the beam-steering device being aimed to emit light from the light emitter into a field of illumination overlapping the field of view;
the beam-steering device including two beam-steering stages each having a polarization grating, the polarization gratings being designed to diffract light from the light emitter based on the polarization state of the light received by the polarization grating;
the beam-steering device including a switchable polarization selector designed to change the polarization state of the light to move the field of illumination relative to the field of view.

2. The LiDAR system as set forth in claim 1, wherein each switchable polarization selector includes a switchable liquid crystal layer operable to be switched between a first state that does not substantially affect the polarization of light traveling therethrough and a second state that alters the polarization of the light traveling therethrough based on voltage applied to the switchable liquid crystal layer.

3. The LiDAR system as set forth in claim 2, further comprising a controller programmed to selectively apply voltage to the switchable liquid crystal layers of the switchable polarization selectors.

4. The LiDAR system as set forth in claim 2, wherein each polarization grating include a switchable liquid crystal layer that diffracts incident light based on applied voltage to the polarization grating.

5. The LiDAR system as set forth in claim 4, further comprising a controller programmed to selectively apply voltage to the switchable liquid crystal layers of the switchable polarization selectors and to selectively apply voltage to the switchable liquid crystal layers of the polarization gratings.

6. The LiDAR system as set forth in claim 2, wherein the switchable polarization selector is a wave plate.

7. The LiDAR system as set forth in claim 1, wherein the polarization grating includes a passive liquid crystal layer.

8. The LiDAR system as set forth in claim 1, wherein the beam-steering stages includes two switchable wave plates and polarization gratings in alternative arrangement.

9. The LiDAR system as set forth in claim 1, wherein the light detector includes a 1-dimensional or 2-dimensional array of photodetectors.

10. The LiDAR system as set forth in claim 1, wherein the field of illumination is smaller than the field of view.

11. A method comprising:
adjusting the aim of a beam-steering device relative to a field of view of a light detector by adjusting a first polarization selector of a first beam-steering stage of the beam-steering device and/or adjusting a second polarization selector of a second beam-steering stage of the beam-steering device;
activating a light emitter aimed at a beam-steering device to emit light into the field of view of a light detector; and
detecting light returned from the field of view with the light detector.

12. The method as set forth in claim 11, wherein the first polarization selector includes a first switchable liquid crystal layer and the second polarization selector includes a second switchable liquid crystal layer and wherein adjusting the aim of the beam-steering device includes selectively applying voltage to the first switchable liquid crystal layer and the second switchable liquid crystal layer.

13. The method as set forth in claim 12, further comprising a first polarization grating adjacent the first polarization selector and including a third polarization selector, and a second polarization grating adjacent the second polarization selector and including fourth polarization selector, and wherein adjusting the aim of the beam-steering device includes selectively applying voltage to the third switchable liquid crystal layer and the third switchable liquid layer.

14. The method as set forth in claim 11, further comprising adjusting the aim of the beam-steering device relative to the field of view to various discrete positions and detecting light returned from the field of view with the light detector at each of the discrete positions.

15. The method as set forth in claim 14, further comprising generating a scene at each discrete position based on the light detected by the light detector and combining the scenes.
